(19) United States
(12) Patent Application Publication
(10) Pub. No.: US 2025/0068290 A1
(43) Pub. Date: Feb. 27, 2025

(54) PINNING VIRTUAL OBJECTS IN AN AUGMENTED REALITY ENVIRONMENT

(71) Applicant: Squint, Inc., San Jose, CA (US)

(72) Inventors: Devin Bhushan, San Jose, CA (US); Dylan Conway, Denver, CO (US); Jim Zhu, Seattle, WA (US)

(21) Appl. No.: 18/456,190

(22) Filed: Aug. 25, 2023

(51) Int. Cl. G06F 3/04815; G01C 21/00; G06F 3/04817; G06F 3/0484; G06F 3/0487; G06T 7/246; G06T 19/00

(52) U.S. Cl. CPC G06F 3/04815; G01C 21/3841; G06F 3/04817; G06F 3/0484; G06F 3/0487; G06T 7/246; G06T 19/00; G06T 2200/24

(57) ABSTRACT

An AR system enables creation and viewing of AR content for sharing of information relating to a physical environment. The AR environment may include one or more virtual objects, which may be pinned to specific locations in the real-world physical environment. The virtual objects may provide information (or access to such information) relating to the object or region of interest. To create pinned virtual objects, the AR system maps a localized physical space and enables tracking of an AR device with respect to the mapped physical space. The AR device may then be physically positioned at the desired location in the physical space and a pinning action may be initiated to generate a pinned virtual object associated with the selected position.

### BACKGROUND

In an augmented reality (AR) system, a display device combines a real-world view of a physical environment with one or more virtual objects. Augmented reality may have various applications in fields such as education, medicine, manufacturing, or entertainment. However, despite the potential benefits of augmented reality, conventional resources for creating augmented reality content are complex to use and have not been widely adopted.

### BRIEF DESCRIPTION OF THE DRAWINGS

Figure (FIG. 1 is an example embodiment of an AR view with pinned virtual objects.

FIG. 2 is an example embodiment of an AR view associated with a procedure.

FIG. 3 is an example embodiment of an AR view associated with a specific step of a procedure.

FIG. 4 is an example embodiment of a set of AR user interface screens associated with creating a pinned virtual object.

FIG. 5 is an example embodiment of an AR system.

FIG. 6 is an example embodiment of an AR device associated with an AR system.

FIG. 7 is an example embodiment of an AR application associated with an AR system.

FIG. 8A is an example embodiment of a technique for generating an environment map associated with a physical space.

FIG. 8B is an example embodiment of a technique for creating a pinned virtual object in association with a physical space in an AR system.

FIG. 9 is an example embodiment of a process for creating a pinned virtual object in association with a physical space in an AR system.

FIG. 10 is an example embodiment of a process for rendering an AR view of a physical space with pinned virtual objects.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made to several embodiments, examples of which are illustrated in the accompanying figures. Wherever practicable, similar or like reference numbers may be used in the figures and may indicate similar or like functionality.

An AR system enables creation and viewing of AR content for sharing of information relating to a physical environment. The AR environment may include one or more virtual objects, which may be pinned to specific locations in the real-world physical environment. The virtual objects may provide information (or access to such information) relating to the object or region of interest. Virtual objects pinned in this manner may be analogous in some ways to a “sticky note” (or pinned note) where a user may tag an object of interest with some relevant information. Unlike a real-world sticky note, a pinned virtual object is not necessarily limited to a concise textual note, and may instead include various multimedia (such as images, video, audio, animations), links to other content, interactive forms, or other digital content. When a pinned virtual object is within the field of view of the AR viewer, the virtual object is displayed at the pinned location. Other virtual objects in the AR environment may be unpinned or floating objects that are not necessarily fixed to a specific location in the physical space. Floating objects may instead be fixed to a certain location in the AR viewer (e.g., always displayed in the bottom left corner), and may therefore appear to move through the physical environment as the field of view of the AR viewer changes.

FIG. 1 illustrates an AR device 110 showing an example AR view 100 of a manufacturing environment that may include various complex machinery. In this example, the AR view 100 shows several virtual objects 102, 104, 106 pinned to different specific positions in the three-dimensional physical space. The pinned virtual objects 102, 104, 106 may correspond to different types of content. For example, a first pinned virtual object 102 is positioned near a central location of a machine and when selected via the touchscreen of the AR device 110, may initiate a start of a “lockout tagout procedure” associated with the machine. Another pinned virtual object 104 provides a simple informational note associated with a particular button of the machine, indicating that the “button here is sticky.” Another pinned virtual object 106 provides a safety warning to “keep fingers out of pinch point.”

As described above, since the virtual objects 102, 104, 106 are pinned to the relevant locations in the physical space, the AR device 110 operates to render the virtual objects 102, 104, 106 such that they appear in their respective pinned position even as the AR device changes position and orientation. In practice, this may involve moving the position, orientation, and/or scale of the virtual objects 102, 104, 106 in the displayed image to compensate for movement of the AR device 110. For example, if the AR device 110 pans to the left, the virtual objects 102, 104, 106 may move towards the right side of the displayed AR view 100 such that the objects 102, 104, 106 appear stable relative to the environment.

In some embodiments, the AR system may be employed to enable a user to explore a physical environment in a free form manner. The virtual objects may be displayed in the AR viewer when the field of view of the AR overlaps the location of a pinned virtual object.

In other usage scenarios, the AR system enables creation and viewing of procedures associated with a physical environment. Here, a procedure may comprise a sequence of tasks set forth in a step-by-step manner. For each step of a procedure, the AR system may present an AR-based user interface that enables the viewer to view the physical environment supplemented with one or more virtual objects that provide instructional guidance for facilitating the procedure step. The virtual objects may include pinned virtual objects presented proximate to relevant real-world objects associated with the procedure step and/or may include floating virtual objects that are unfixed from a particular position. In some situations, the virtual objects may provide navigational instructions to guide a user to a particular location in the physical environment associated with a procedure step. The virtual objects may furthermore point to, or otherwise visually indicate, a particular object or region of interest in the physical environment associated with the procedure step. Steps of a procedure may be presented sequentially, with the interface advancing upon completion of each step.

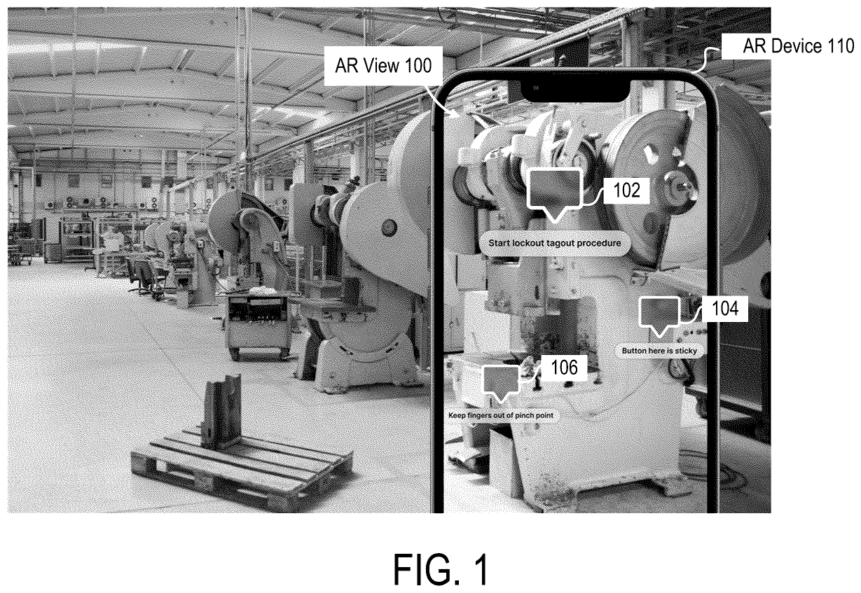

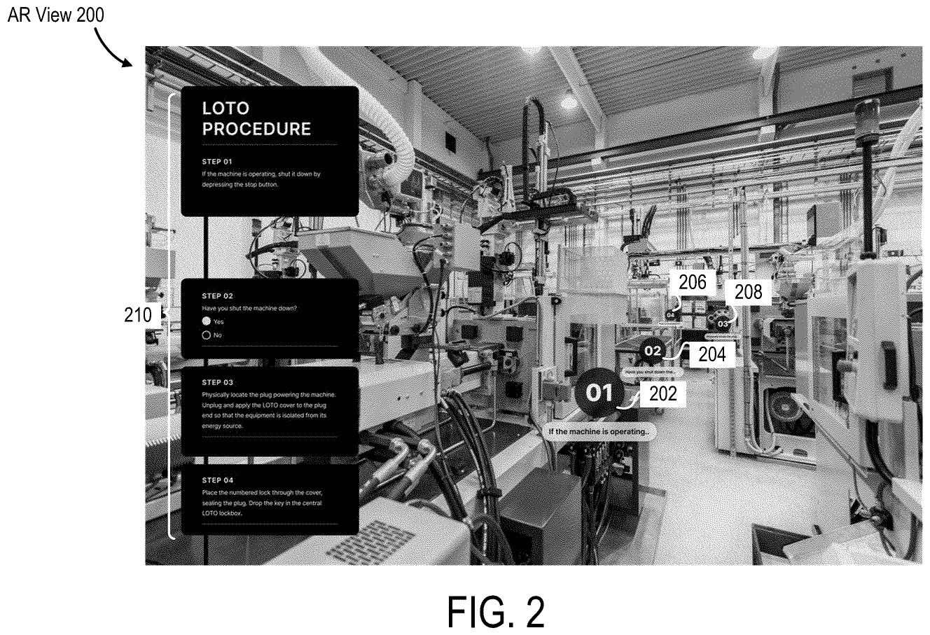

For example, FIG. 2 illustrates an example AR view 200 associated with a procedure to be performed in a manufacturing environment. Here, the AR view 200 includes several pinned virtual objects 202, 204, 206, 208 that correspond to different sequential steps of a procedure to be performed using different components of the manufacturing machinery. The pinned virtual objects 202, 204, 206, 208 are displayed such that they appear to be fixed in the physical space proximate to the relevant component regardless of the position and orientation of the AR viewing device in the physical space. The AR view 200 also includes several floating virtual objects 210 that provide various general information about the procedure and individual steps. These virtual objects 210 may remain positioned on a left side of the viewing interface unfixed to any specific position in the physical space.

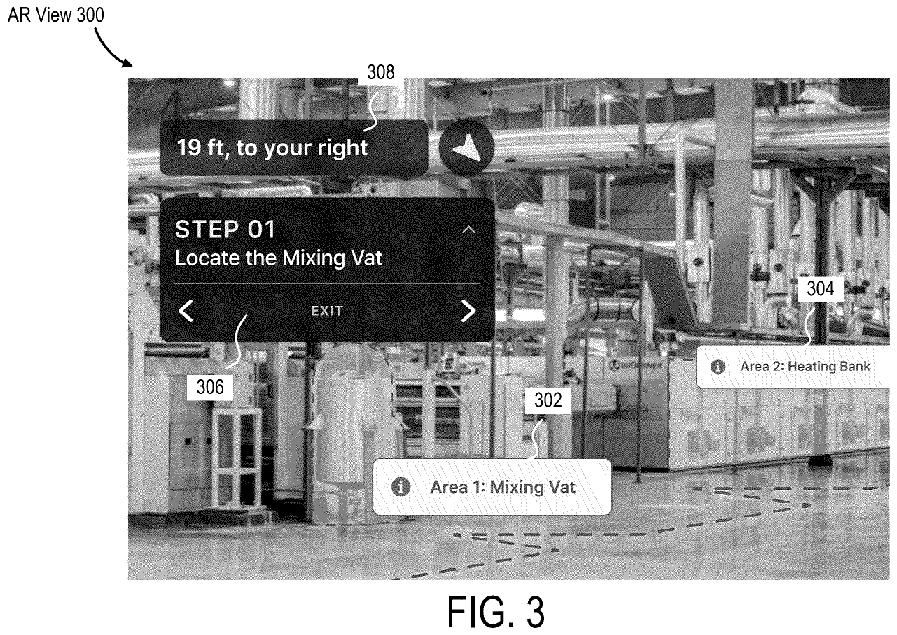

FIG. 3 illustrates another example AR view 300 relating to a specific step of a procedure (e.g., Step 1—“locate the mixing vat”). In this example, pinned virtual objects 302, 304 are utilized to designate relevant areas of a factory (e.g., “Area 1: Mixing Vat”, “Area 2: Heating Bank.”). The pinned virtual objects 302, 304 include both labels and dashed lines outlining the relevant area. Furthermore, these objects 302, 304 include an information link (“i” icon) that may provide access to additional linked information in the form of text, multimedia, or other digital content. The AR view 300 also includes a virtual object 306 describing the current step to be performed and a virtual object 308 for navigation instructions associated with the step. For example, the navigation instructions direct the viewer to the relevant position in the physical space “19 ft, to your right”, and also includes a navigation arrow showing the specific direction to the desired user position for performing the step of the procedure.

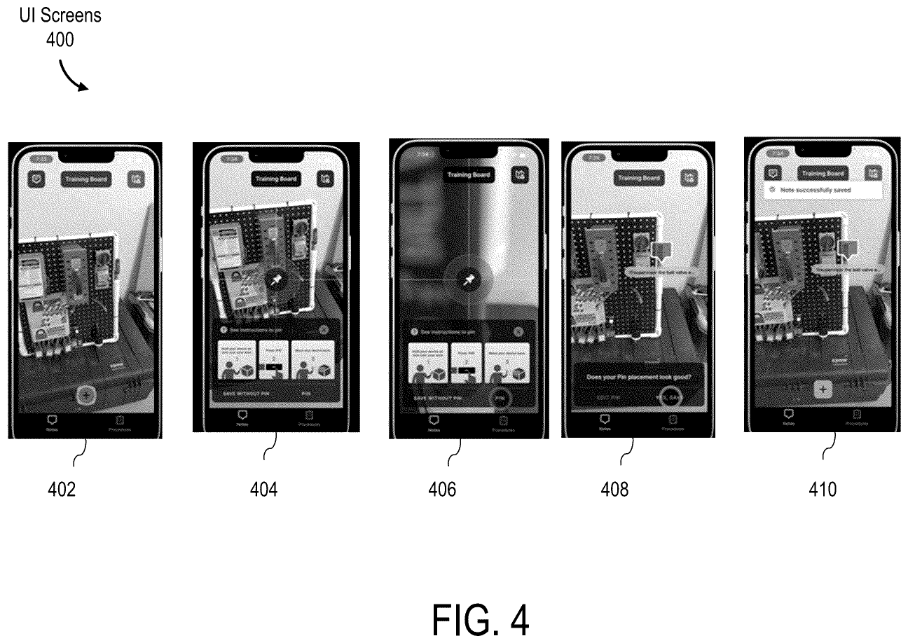

FIG. 4 illustrates a set of user interface screens 400 associated with another example use of the described AR system. In this example, the AR system enables creation of pinned virtual objects using an intuitive “tap to pin” action. For example, a first interface screen 402 shows a real-time view of a physical environment including a training board associated with one or more tasks. A second interface screen 404 provides on-screen control elements and instructions for pinning a virtual object to a location on the training board. In this example, a “pin” icon is shown in the center of the screen to help the user visualize where the pinned virtual object will be placed. In interface screen 406, the user selects a location to pin the virtual object and executes the pin action to pin the virtual object (e.g., selecting the “pin” control element in the user interface). In interface screen 408, a confirmation dialog is shown allowing the user to confirm that the pinned virtual object is correctly positioned. Interface screen 410 shows the result of the pinned virtual object being successfully placed.

An AR system enabling the techniques of FIGS. 1-4 may be employed for various instructional purposes. For example, the AR system may be employed to guide a user through processes such as a manufacturing process, a diagnostic process, a repair process, a safety check process, a calibration process, or other relevant process. In addition to usage scenarios in manufacturing environments like those shown in FIGS. 1-3, the AR system may be similarly utilized in other environments. For example, in an office environment, the AR system may be used to provide procedures or information relating to use of devices such as copying machines, a coffee maker, or a printer. In a construction environment, the AR system may be employed to precisely indicate construction tasks (e.g., where to put a post), operate construction equipment, etc. The AR system can further be deployed for training purposes associated with various tasks such as performing aviation procedures within a cockpit, training medical personnel to carry out a medical process, assisting an appliance repairperson through a particular repair or diagnostic procedure, etc.

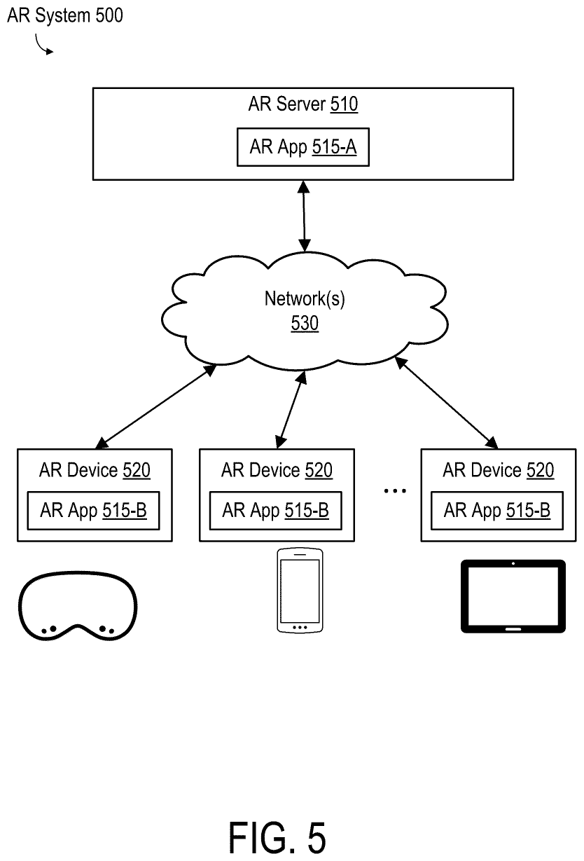

FIG. 5 is a block diagram of an AR system 500 for enabling any of the above-described techniques according to one embodiment. The AR system 500 includes a network 530, an AR server 510, and one or more AR devices 520. In alternative configurations, different and/or additional components may be included in the AR system 500.

The AR device 520 comprises a computing device for processing and presenting AR content. In various embodiments, the AR device 520 may comprise, for example, a mobile device, a tablet, a laptop computer, a head-mounted display device, a smart goggle or glasses device, a smart contact lens (or pair of lenses), or other device capable of displaying AR content. The AR device 520 may furthermore include various input and output devices that enable a user to input commands, data, or other information, and to view and/or interact with various output information. The AR device 520 may furthermore include network connectivity via a wired and/or wireless connection to enable communications with the AR server 510 or other network-connected devices. The AR device 520 may include one or more processors and one or more non-transitory computer-readable storage mediums that store instructions executable by the one or more processors for carrying out the functions attributed herein to the AR device 520.

The AR server 510 comprises one or more computing devices for facilitating an AR experience in conjunction with one or more AR devices 520. The AR server 510 may be implemented as one or more traditional physical servers and/or one or more virtual machines. The AR server 510 may comprise one or more on-site processing and/or storage devices coupled to one or more AR devices 520 via a private network, or may comprise cloud processing and storage technologies, or a combination thereof. For example, in a cloud-based implementation, the AR server 510 may include multiple distributed computing and storage devices managed by a cloud service provider. The AR server 510 may include an aggregation of multiple servers responsible for different functions and may include various physical and/or virtual servers managed and/or operated by different entities. In various implementations, the AR server 510 may comprise one or more processors and one or more non-transitory computer-readable storage mediums that store instructions executable by the one or more processors for carrying out the functions attributed to the AR server 510 herein.

The AR server 510 may execute a server-side AR application 515-A and the one or more AR devices 520 may respectively execute a client-side AR application 515-B. The server-side AR application 515-A and client-side AR application 515-B may operate in coordination with each other to facilitate various functions of the AR system 500 described herein. In various implementations, certain functions may be executed entirely on the AR server 510, entirely on the AR device 520, or jointly between the AR server 510 and the AR device 520. For example, functions and/or data that are computationally and/or storage intensive or functions that may be shared between a large number of AR devices 520 may benefit from being executed and/or stored by the server-side AR application 515-A. Functions that involve localized data and/or preferably are not subject to latency, bandwidth, and/or other connectivity constraints may benefit from execution on by the client-side AR application 515-B. In an embodiment, the AR server 510 may enable the AR device 520 to download the client-side AR application 515-B and/or may push out periodic updates. As used herein, reference to the AR application 515 may refer to an application that can be executed by the AR device 520 in some embodiments, the AR server 510 in other embodiments, or jointly by the AR device 520 and the AR server 510 in further embodiments.

The one or more networks 530 provides communication pathways the AR server 510 and the one or more AR devices 520. The network(s) 530 may include one or more local area networks (LANs) and/or one or more wide area networks (WANs) including the Internet. Connections via the one or more networks 530 may involve one or more wireless communication technologies such as satellite, WiFi, Bluetooth, or cellular connections, and/or one or more wired communication technologies such as Ethernet, universal serial bus (USB), etc. The one or more networks 530 may furthermore be implemented using various network devices that facilitate such connections such as routers, switches, modems, firewalls, or other network architecture.

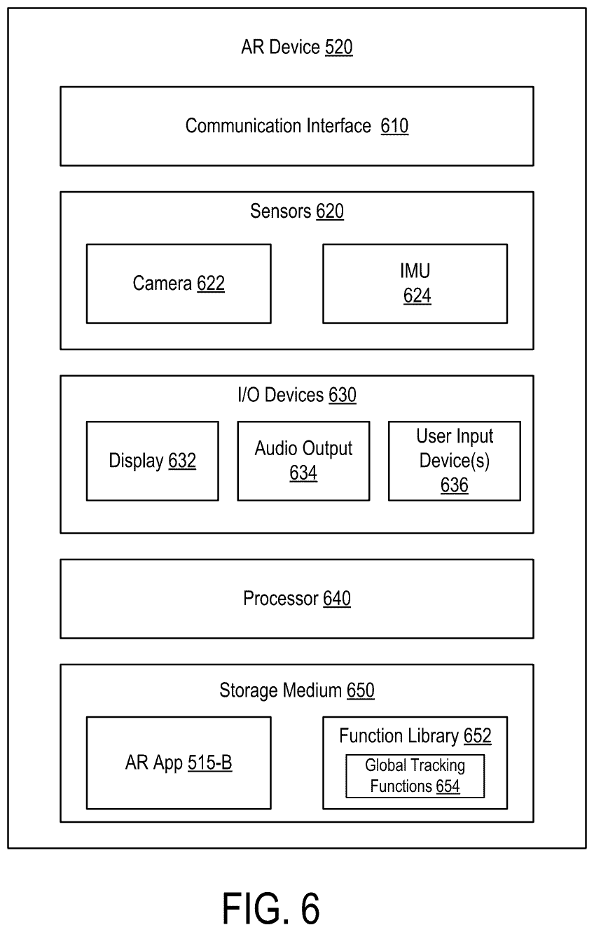

FIG. 6 is a block diagram illustrating an embodiment of an AR device 520. In the illustrated embodiment, the AR device 520 comprises a communication interface 610, sensors 620, I/O devices 630, one or more processors 640, and a storage medium 650. Alternative embodiments may include additional or different components.

The communication interface 610 facilitates communication between the AR device 520 and the one or more networks 530. The communication interface 610 may comprise a wireless interface such as a WiFi interface, a cellular interface (e.g., 3G, 4G, 5G, etc.) a Bluetooth interface, or other wireless interface. In other implementations, the communication interface 610 may include one or more wired communication interfaces such as, for example, a Universal Serial Bus (USB) interface, a Lightning interface, or other communication interface. The communication interface 610 may furthermore include a combination of different interfaces.

The sensors 620 detect various conditions associated with the operating environment of the AR device 520. In an example implementation, the sensors 620 may include at least one camera 622 and an inertial measurement unit (IMU) 624. The camera 622 captures digital images and/or video of the physical environment. In various embodiments, the camera 622 may include a conventional digital camera (typical of those integrated in mobile devices and tablets), a stereoscopic or other multi-view camera, a lidar camera or other depth-sensing camera, a radar camera, or other type of camera or combination thereof. The IMU 624 senses motion of the AR device 520 via one or more motion sensing devices such as an accelerometer and/or gyroscope. Examples of motion data that may be directly obtained or derived from the IMU 624 include, for example, position, velocity, acceleration, orientation, angular velocity, angular acceleration, or other position and/or motion parameters. In some embodiments, the IMU 624 may include various additional sensors such as a temperature sensor, magnetometer, or other sensors that may aid in calibrating and/or filtering the IMU data to improve accuracy of sensor data.

The sensors 620 may optionally include other sensors (not shown) for detecting various conditions such as, for example, a location sensor (e.g., a global positioning system), audio sensor, a temperature sensor, humidity sensor, pressure sensors, or other sensors.

The input/output devices 630 include various devices for receiving inputs and generating outputs for the AR device 520. In an embodiment, the input/output devices may include at least a display 632, an audio output device 634, and one or more user input devices 636. The display device 632 presents images or video content associated with operation of the AR device 520. The display device 632 may comprise, for example, an LED display panel, an LCD display panel, or other type of display. In head-mounted devices, the display device 632 may comprise a stereoscopic display that presents different images to the left eye and right eye to create the appearance of three-dimensional content. The display device 632 may furthermore present digital content that combines rendered graphics depicting virtual objects and/or environments with content captured from a camera 622 to enable an augmented reality presentation with virtual objects overlaid on a physical environment.

The audio output device 634 may include one or more integrated speakers or a port for connecting one or more external speakers to play audio associated with the presented digital content.

The user input device 636 may comprise, for example, a touchscreen interface, a microphone for capturing voice commands or voice data input, a keyboard, a mouse, a trackpad, a joystick, a gesture recognition system (which may rely on input from the camera 322 and/or IMU 324), a biometric sensor, or other input device that enables user interaction with the client-side AR application 515-B.

In further embodiments, the input/output devices 630 may include additional output devices for providing feedback to the user such as, for example, a haptic feedback device and one or more light emitting diodes (LEDs).

The storage medium 650 (e.g., a non-transitory computer-readable storage medium) stores various data and instructions executable by the processor 640 for carrying out functions attributed to the AR device 520 described herein. In an embodiment, the storage medium 650 stores the client-side AR application 515-B and a function library 652.

The function library 652 may include various functions that can be employed by the client-side AR application 515-B. For example, the function library 652 may comprise various operating system (OS) functions or standard development kit (SDK) functions that are accessible to the client-side AR application 515-B via an application programming interface (API). The function library 652 may include functions for processing sensor data from the sensor 620 such as, for example, performing filtering, transformations, aggregations, image and/or video processing, or other processing of raw sensor data. The client-side AR application 515-B may utilize the function library 652 for performing tasks such as depth estimation, feature generation/detection, object detection/recognition, location and/or orientation sensing, or other tasks associated with operation of the client-side AR application 515-B. The function library 652 may further facilitate various functions associated with rendering AR content such as performing blending operations, physics simulations, image stabilization, or other functions.

The function library 652 may include a set of global tracking functions 654 that may be employed to track a state of the AR device 520, which may include a pose (position and orientation) and/or motion parameters (e.g., velocity, acceleration, etc.). The global tracking functions 654 may utilize IMU data from the IMU 624 and/or visual information from the camera 622. In example embodiment, tracking may be performed using visual inertial odometry (VIO) techniques.

The global tracking functions 654 generally perform tracking during a given tracking session relative to a global origin that corresponds to an initial state of the AR device 520 when a tracking session is invoked. State data may include position, orientation, or other state parameters associated with VIO-based tracking (e.g., scale). State data may be stored as transformation matrices describing changes between states. For example, state data may be described as 4×4 transformation matrices in a standardized representation employed by function libraries 652 native to common mobile device operating systems.

The global origin may be identified by a default state and subsequent tracking data describe the state relative to that state. The global origin may correspond to any arbitrary position or orientation in the physical space when the tracking session is initialized. Thus, the global origin may correspond to a different position and orientation in the real world for different tracking sessions. Because tracking data from the global tracking functions 654 are relative to an arbitrary initial state, tracking data between different tracking sessions do not necessarily correspond to the same physical state of the AR device 520.

The global tracking functions 654 may furthermore include functions for identifying and tracking feature points representing visual features of a physical space. This feature point detection may further aid tracking. Visual features may include edge information, contour information, color information, contrast information, or other visual information that enables the AR device 520 to estimate its pose relative to a physical space. Selected visual features may be limited to those that are robust to changes in viewing angle, distance, lighting conditions, camera-specific parameters, or other variables. These features enable detection and matching of features depicted in different images even when the images are captured under different conditions, with different devices, and/or from different perspectives.

Visual features may be stored as feature points by estimating the relative states (e.g., distances and viewing angles) between the detected visual features and the AR device 520. The feature points may be described relative to the global origin (based on tracking data between the AR device 520 and the global origin, and state data such as relative distance and viewing angle between the AR device 520 and the detected visual features). As the AR device 520 observes visual features that match previously stored feature points, the stored information may be applied to update tracking of the AR device 520. This technique may reduce tracking error associated with drift or noise.

In an embodiment, specific tracking functions may be implemented via calls to the global tracking functions 654 in a manner that is not necessarily transparent to the client-side AR application 515-B. The client-side AR application 515-B may access a limited set of relevant tracking data generated via the global tracking functions 654 such as state data associated with feature points and real-time or historic state information for the tracked AR device 520 relative to the global origin for the tracking session.

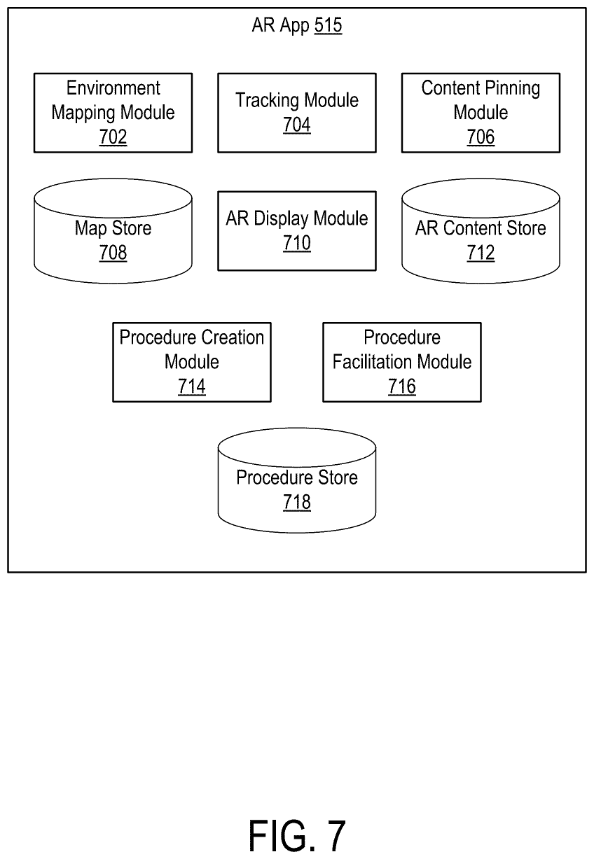

FIG. 7 illustrates an example embodiment of an AR application 515. The AR application 515 includes an environment mapping module 702, a tracking module 704, a content pinning module 706, a map store 708, an AR display module 710, an AR content store 712, a procedure creation module 714, a procedure facilitation module 716, and a procedure store 718. In alternative embodiments, the AR application 515 may include different or additional modules. As described above, different modules described in FIG. 7 may execute on the client-side AR application 515-B, the server-side AR application 515-A, or a combination thereof. For example, in one implementation, the environment mapping module 702, the tracking module 704, the content pinning module 706, the AR display module 710, and the procedure facilitation module 716 all execute as components of the client-side AR application 515-B, while the map store 708, AR content store 712, and the procedure store 718 are stored to the AR server 510 and managed by the server-side AR application 515-A. However, in various alternative implementations, certain functions of one or more of the described modules 702, 704, 706, 710, 714, 716 may instead be carried out via function calls to the server-side AR application 515-A, which may perform various processing and return results to the client-side AR application 515-B.

The environment mapping module 702 generates a map of an environment associated with creation and view of AR content. The environment map may include a structured set of data describing a localized physical space. The environment mapping module 702 may be initiated based on an input from a user to begin mapping a space or may be initiated automatically in response to another trigger event such as upon opening the client-side AR application 515-B, upon the detecting presence of the AR device 520 in a new physical space that has not previously been mapped (or has been mapped incompletely), upon the user selecting to create a new procedure, or upon the user initiating another action that relies on an environment map.

When creating a new environment map, the environment mapping module 702 establishes an anchor point in the localized physical space that provides a reference for the environment map. In an embodiment, the anchor point may be a user-selected point in the localized physical space. For example, in one technique, the client-side AR application 515-B establishes the anchor point as an intersection point of a ray cast from the camera and a detected surface capture by the camera. In other embodiments, an anchor point may be selected in an automated way or based on another trigger event. The position of the anchor point relative to the global origin for the tracking session may be determined using tracking techniques described above.

Feature points (which are natively tracked relative to the global origin for the session) may then be transformed so that they are described relative to the established anchor point instead of the global origin (i.e., based on the tracking data between the global origin and the anchor point, and between the global origin and the feature points). The feature points (now stated relative to the anchor point) are stored to the environment map for the localized physical space. In this way, the feature points in the environment map become fixed to real-world points in the physical space and the data in the environment map is agnostic to the global origin (which may vary between tracking sessions). Feature points for storing the environment map may include features points established by the tracking module 704 prior to the anchor point being selected, and/or feature points established after the anchor point is established.

In an embodiment, the environment mapping module 702 may output guidance (via a user interface of the AR device 520) to guide a user through an environment mapping process. In this implementation, the guidance may direct the user in a manner that facilitates capturing an environment map having a significant number of feature points at sufficiently varied positions. In another embodiment, the environment mapping module 702 may operate in the background to facilitate generation of the environment map as a user naturally moves around an environment, without AR device 520 necessarily providing express guidance. The environment map may be stored to the map store 708.

The tracking module 704 estimates a state of the AR device 520 (e.g., position and location) during a tracking session. The start of a tracking session may be initialized when the client-side AR application 215-B is opened, or in response to another trigger condition (e.g., a manual request). Prior to mapping a localized space, the tracking module 704 may utilize the global tracking functions 654 to generate tracking data and feature points described relative to a global origin. The tracking module 704 may furthermore detect when the AR device 520 is in a localized environment that has been previously mapped and identify the relevant environment map. This detection may occur, for example, based on matching observed feature points in a tracking session (as obtained from the global tracking functions 654) to stored feature points associated with an environment map. Once the relevant environment map is established, the tracking module 704 may transform the global tracking data (which is described relative to the global origin for the tracking session) to localized tracking data described relative to anchor point. For example, the tracking module 704 obtains the global positions of the feature points from the global tracking module, obtains the local positions (relative to the anchor point) of the feature points from the environment map, and then determines a transformation between global tracking data and the localized tracking data for subsequent localized tracking of the AR device relative to the anchor point.

The content pinning module 706 facilitates pinning of virtual objects to a selected position in the physical space. The pinned position (with reference to a particular environment map) and the associated virtual object (or a reference to the virtual object) may be stored to the map store 708 and may reference a virtual object stored to the AR content store 712. In an embodiment, the AR content store 712 may be integrated with the map store 708 in a single database, or may comprise a separate data structure.

To initiate pinning, the user physically positions the AR device 520 at the desired pin position in the physical space and initiates the pinning action through a direct or implied command. For example, in one embodiment, the user may select a control element on a touch screen or provide a voice command to initiate pinning. In another embodiment, a motion gesture associated with the tracked motion of the AR device 520 may initiate pinning. For example, the content pinning module 706 may detect a tapping gesture (or double tapping or triple tapping) of the AR device 520 against an actual simulated surface. In another embodiment, pinning may be initiated upon detecting that the AR device 520 is stationary for a predefined length of time. In further embodiments, a combination of inputs may initiate pinning. For example, the user may initiate a pinning action via a user interface control, and the pinning module 706 may then wait until the AR device 520 is sufficiently stable to capture the pinning position.

In an example scenario, the content pinning module 706 may enable the user to first select the pin position and then create the virtual object. Here, after initiating the pinning action, the AR device 520 may prompt the user to input content for the virtual object to be associated with the pinned position. For example, the content may include structured or unstructured text, one or more images, one or more videos, one or more animations, an interactive form, a link to multimedia or other data, or other information. The virtual object may be represented by content itself (e.g., the entered text or image) and/or an interactive virtual icon associated with the content. For example, the virtual object may take the form of a sticky note graphic, that may include various text or images, and may be displayed in the AR environment in a manner that appears analogous to a real-life sticky note placed on a surface.

In another example scenario, the content pinning module 706 may enable the user to first create the virtual object (in the manner described above) and then select the pin position for the virtual object. In further embodiments, the content pinning module 706 may allow the user to select from a set of stored virtual objects.

The AR display module 710 renders an AR view of the physical environment based on the virtual objects (and corresponding pinned positions) in the AR content store 712 and the environment map from the map store 708. In operation, the AR display module 710 obtains tracking information from the tracking module 704 to identify an environment map corresponding to its current position and estimated local tracking data (relative to the anchor point). Based on the tracked state, the AR display module 710 determines when a pinned position of a virtual object (from the AR content store 712) is within the field of view of the AR device 720 and renders the virtual object in an AR view at a corresponding position (i.e., such that it appears to the viewer that the virtual object is present in the physical environment at the pinned position).

In an embodiment, the AR display module 710 may optionally display other virtual content that is not necessarily associated with pinned virtual objects. For example, the AR display module 710 could display virtual objects associated with navigation instructions to guide the user to a particular location or other information generally relevant to the physical space. These virtual objects may be rendered as floating virtual objects that remain in the same position in the field of view of the AR device 720 independent of its motion rather than being pinned to a real-world position. For example, navigation instructions may be displayed in the lower right or lower left corners of the display.

In an embodiment, the specific content displayed by the AR display module 710 may be dependent on the detected physical space where the AR device 520 is present, as determined by the tracking module 704 based on the stored environment maps. For example, in an office setting, the AR device 520 may detect when the AR device 520 is in the physical space proximate to a coffee machine (based on real-time visual features captured by the camera), obtain the environment map associated with the coffee machine physical space to facilitate further tracking, and also load a set of display rules associated with that physical space. The display rules may include displaying pinned virtual objects associated with the coffee machine physical space, but may also include other display rules such as invoking output of a set of guided procedures for making coffee.

The procedure creation module 714 facilitates creation of procedures that may be associated with one more environment maps. As described above, a procedure may include a sequence of steps to be performed in the physical space. Each step may be presented in an AR view that may include various virtual objects (including pinned virtual objects and/or floating virtual objects) to facilitate performance of the procedure. The procedure creation module 714 may provide various user interface tools to enable a creator to create or modify procedures and store them to the procedure store 718.

The procedure facilitation module 716 facilitates presentation of AR views associated with carrying out a stored procedure from the procedure store 718. For each step, the procedure facilitation module 416 may load relevant virtual objects associated with the procedure step and render them in the AR view of the AR device 520 as the AR device 520 moves through the physical space. In various embodiments, the procedure facilitation module 716 may provide user interface tools to enable the user to advance forward or backward between steps, to mark steps as complete, to provide feedback or other notes with respect to particular steps, or perform other actions relevant to the procedure.

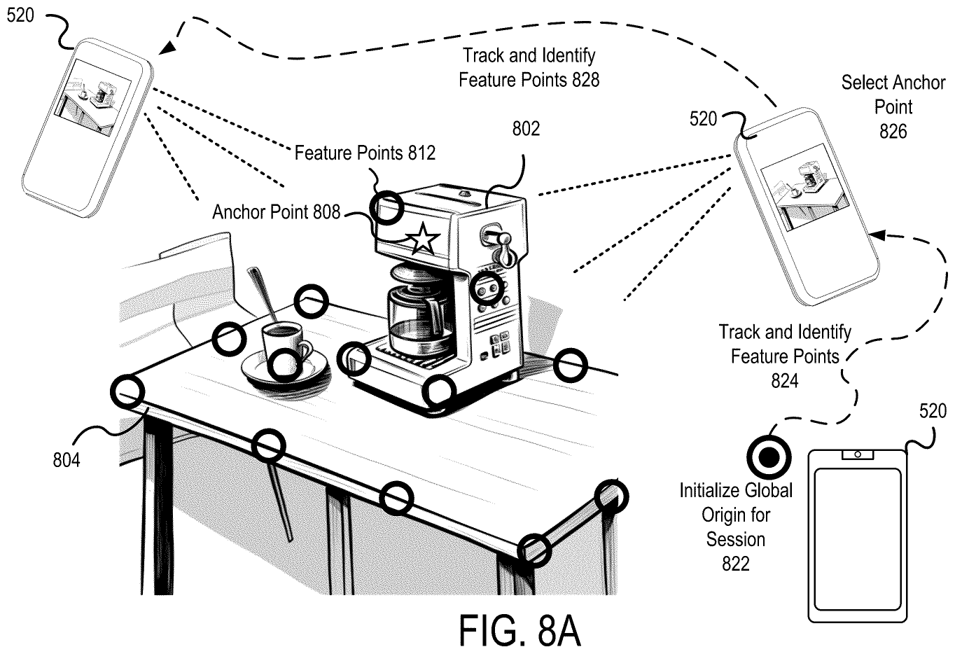

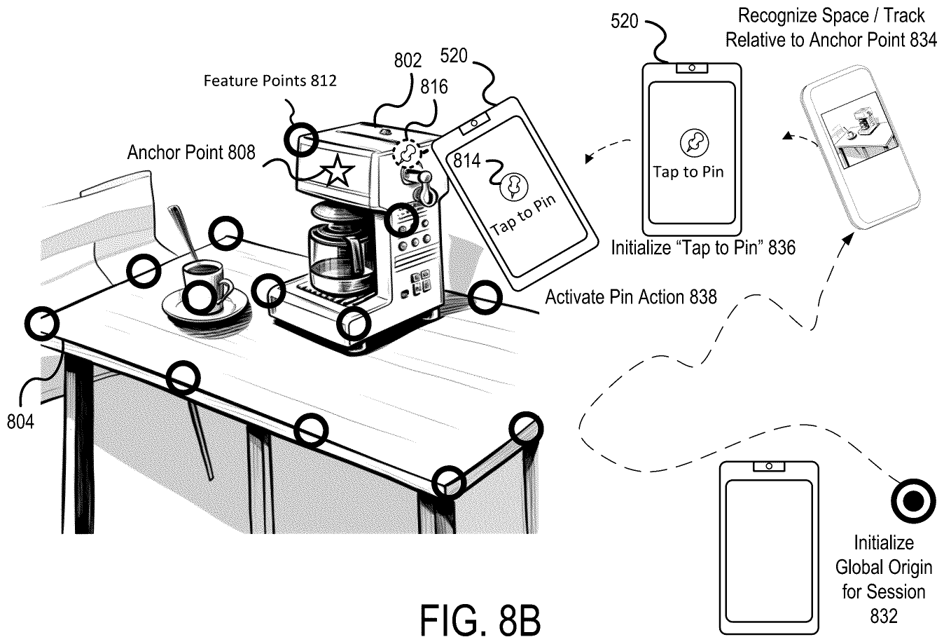

FIG. 8A illustrates an example technique for generating an environment map. In this example, the environment includes a coffee maker 802 sitting on a table 804. A tracking session begins when the AR device 520 is at a global origin 822 (which may be an arbitrary position and orientation). As the AR device 520 moves around the physical space, the tracking module 704 is invoked to track 824 motion of the AR device 520 and establish feature points 812 described relative to the global origin 822 (using the global tracking functions 654). For example, visual features associated with feature points 812 may correspond to corners and/or edges of the table 804, corners or edges of the coffee maker 802, or other visually distinguishable elements. An anchor point 808 may be established 826 as a local reference point for the physical space (in this case, on a surface of the coffee maker 802). After establishing the anchor point 808, the AR device 520 may continue to move around the environment to provide additional mapping data. Here, the tracking module 704 may continue to track 828 the AR device 520 and establish additional feature points 812 relative to the global origin 822, which may then be transformed to local tracking data and feature points relative to the established anchor point 808. The local feature points are stored to an environment map.

In FIG. 8B, the AR device 520 is present in the physical space previously mapped. A tracking session may begin with respect to a global origin 832 (which may be different from the global origin 822 associated with mapping). The tracking module 704 initially tracks the AR device 520 relative to the global origin 832. As feature points are mapped, the AR device 520 recognizes 834 that it is in a previously mapped space, and identifies the relevant environment map. The tracking module 704 may then utilize the feature point data in the environment map to transform the global tracking data into localized tracking data and continue tracking relative to anchor point 808 associated with the environment map. In this example, the user desires to pin a note to a position 816 on the side of the coffee maker 802 near its control buttons (e.g., to explain how to operate the coffee maker). To do this, the user initializes 836 the “tap to pin” function. The user then positions the AR device 520 at the desired position 816 in the physical space and selects the “tap to pin” element 814 to activate 838 the pin action. As described above, various alternative techniques may instead be employed to initiate the pinning action such as using motion gestures, voice commands, or other inputs.

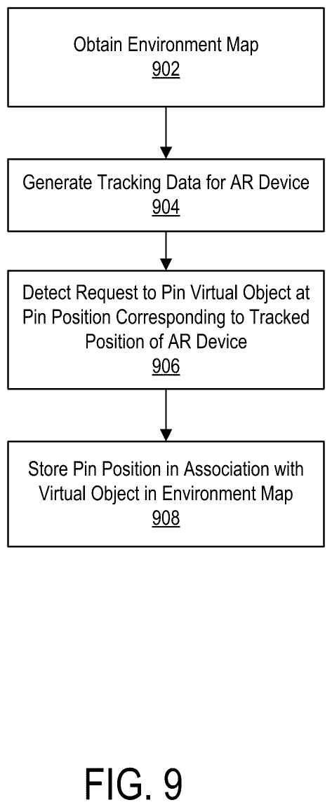

FIG. 9 illustrates an example embodiment of a process for pinning a virtual object to a physical location in the environment map. The AR application 515 obtains 902 an environment map associated with the localized physical environment. Obtaining the environment map could include detecting that the AR device 520 is present at a location associated with an existing environment map from the environment map store 708, or may include creating a new environment map. The AR application 515 generates 904 tracking data associated with the AR device 520 as the AR device 520 moves through the localized physical environment. The tracking data may include real-time estimates of the position and orientation of the AR device 520. Tracking may be based on IMU data, visual motion analysis data, and/or information about feature points stored in the environment map. The AR application 515 detects 906 a request to pin a virtual object to a pin position that corresponds to the tracked position of the AR device 520. The request may be based on an express selection of a control element of the AR device 520, a voice input, a gesture input, or other input mechanism. Alternatively, the request may be inferred based on various detected conditions. Responsive to the request, the AR application 515 stores a pin position (corresponding to the current position of the AR device 520 relative to the anchor point) associated with a virtual object to the environment map. Content associated with the virtual object may be created prior to selecting the pin position or may be created after selecting the pin position.

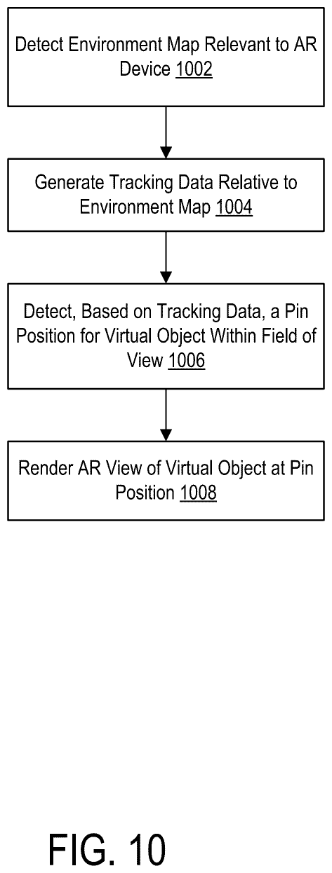

FIG. 10 illustrates an example embodiment of a process for viewing an AR environment that includes pinned virtual objects. The AR application 515 detects 1002 an environment map associated with its current localized physical space. Here, the detection may be based on matching visual features observed by the AR device 520 to visual features stored to one or more feature points in the environment map. The AR application 515 generates 1004 tracking data corresponding to the estimated real-time position and orientation of the AR device 520 relative to an anchor point associated with the environment map. Based on the tracking data, the AR application 515 identifies 1006 when a pinned position for a virtual object is within a field of view of the AR device 520. Responsive to this detection, the AR application 515 renders 1008 the virtual object at the pinned position.

The figures and the description relate to embodiments by way of illustration only. Alternative embodiments of the structures and methods disclosed herein will be readily recognized as viable alternatives that may be employed without departing from the principles of the embodiments.

Upon reading this disclosure, those of skill in the art will still appreciate additional alternative structural and functional designs for the disclosed embodiments from the principles herein. Thus, while particular embodiments and applications have been illustrated and described, the disclosed embodiments are not limited to the precise construction and components disclosed herein. Various modifications, changes and variations, which will be apparent to those skilled in the art, may be made in the arrangement, operation and details of the disclosed embodiments herein without departing from the scope.

1. A method for creating virtual objects pinned to respective physical positions in an augmented reality view of a localized physical environment, the method comprising:
obtaining an environment map for the physical environment, the environment map associated with an anchor point in the localized physical environment;
generating first tracking data to track estimated position of a first augmented reality device relative to the anchor point associated with the environment map for the localized physical environment;
detecting an input requesting to pin a virtual object in the physical environment;
responsive to the input, obtaining, based on the tracking data, a current estimated position of the augmented reality device; and
storing in association with the environment map, a pinned position for the virtual object based on the current estimated position of the augmented reality device.

2. The method of claim 1, wherein the environment map comprises one or more feature points described relative to the anchor point, the at least one or more feature points including visual features detectable from image data of the localized physical environment and position data associated with estimated positions of the visual features relative to an anchor point.

3. The method of claim 2, wherein obtaining the environment map comprises:
sensing motion of the augmented reality device and synchronously capturing the visual features of the localized physical environment as the augmented reality device moves relative to the localized physical environment;
generating the feature points based on the motion and the visual features; and
storing the feature points to the environment map.

4. The method of claim 2, wherein obtaining the environment map comprises:
detecting correspondence between visual features observed by the augmented reality device and the visual features stored to the environment map; and
identifying the environment map from a stored set of environment maps based on the detected correspondence.

5. The method of claim 1, wherein detecting the input requesting to pin the virtual object comprises at least one of:
detecting a selection of a user interface control element of the augmented reality device;
detecting a predefined voice control input; and
detecting a predefined gesture associated with motion of the augmented reality device.

6. The method of claim 1, further comprising:
prior to detecting the input requesting to pin the virtual object, obtaining via a user interface, content associated with the virtual object.

7. The method of claim 1, further comprising:
subsequent to detecting the input, generating a user prompt for a user to input content associated with the virtual object; and
obtaining the content associated with the virtual object responsive to the user prompt.

8. The method of claim 1, wherein the virtual object comprises at least one of: text, an image, an animation, a video, a structured procedure, an interactive form, and a control element associated with accessing media content.

9. The method of claim 1, further comprising:
subsequent to storing the pinned position for the virtual object, determining that the augmented reality device is in the localized physical environment associated with the environment map;
generating second tracking data relative to the anchor point specified in the environment map for the physical environment;
detecting, based on the second tracking data, that the pinned position is within a field of view of the augmented reality device; and
rendering an augmented reality view of the virtual object at the pinned position.

10. The method of claim 9, wherein determining that the augmented reality device is in the localized physical environment associated with the environment map comprises:
detecting correspondence between visual features observed by the augmented reality device and the visual features associated with feature points stored to the environment map; and
identifying the environment map from a stored set of environment maps based on the detected correspondence.

11. The method of claim 10, wherein generating the second tracking data comprises:
initializing an estimated initial position of the augmented reality device relative to the anchor point based on the visual features observed by the augmented reality device and position data associated with the feature points in the environment map.

12. A non-transitory computer-readable storage medium storing instructions for creating virtual objects pinned to respective physical positions in an augmented reality view of a localized physical environment, the instructions when executed by one or more processors causing the one or more processors to perform steps including:
obtaining an environment map for the physical environment, the environment map associated with an anchor point in the localized physical environment;
generating first tracking data to track estimated position of a first augmented reality device relative to the anchor point associated with the environment map for the localized physical environment;
detecting an input requesting to pin a virtual object in the physical environment;
responsive to the input, obtaining, based on the tracking data, a current estimated position of the augmented reality device; and
storing in association with the environment map, a pinned position for the virtual object based on the current estimated position of the augmented reality device.

13. The non-transitory computer-readable storage medium of claim 12, wherein the environment map comprises one or more feature points described relative to the anchor point, the at least one or more feature points including visual features detectable from image data of the localized physical environment and position data associated with estimated positions of the visual features relative to an anchor point.

14. The non-transitory computer-readable storage medium of claim 13, wherein obtaining the environment map comprises:
sensing motion of the augmented reality device and synchronously capturing the visual features of the localized physical environment as the augmented reality device moves relative to the localized physical environment;
generating the feature points based on the motion and the visual features; and
storing the feature points to the environment map.

15. The non-transitory computer-readable storage medium of claim 13, wherein obtaining the environment map comprises:
detecting correspondence between visual features observed by the augmented reality device and the visual features stored to the environment map; and
identifying the environment map from a stored set of environment maps based on the detected correspondence.

16. The non-transitory computer-readable storage medium of claim 12, wherein detecting the input requesting to pin the virtual object comprises at least one of:
detecting a selection of a user interface control element of the augmented reality device;
detecting a predefined voice control input; and
detecting a predefined gesture associated with motion of the augmented reality device.

17. The non-transitory computer-readable storage medium of claim 12, further comprising:
prior to detecting the input requesting to pin the virtual object, obtaining via a user interface, content associated with the virtual object.

18. The non-transitory computer-readable storage medium of claim 12, further comprising:
subsequent to detecting the input, generating a user prompt for a user to input content associated with the virtual object; and
obtaining the content associated with the virtual object responsive to the user prompt.

19. The non-transitory computer-readable storage medium of claim 12, wherein the virtual object comprises at least one of: text, an image, an animation, a video, a structured procedure, an interactive form, and a control element associated with accessing media content.

20. An augmented reality device comprising:
one or more cameras for capturing image data;
one or more motion sensors for capturing motion data;
one or more processors; and
a non-transitory computer-readable storage medium storing instructions for creating virtual objects pinned to respective physical positions in a physical environment, the instructions when executed by one or more processors causing the one or more processors to perform steps including:
obtaining an environment map for the physical environment, the environment map associated with an anchor point in the localized physical environment;
generating, based on the image data and the motion data, first tracking data to track estimated position of a first augmented reality device relative to the anchor point associated with the environment map for the localized physical environment;
detecting an input requesting to pin a virtual object in the physical environment;
responsive to the input, obtaining, based on the tracking data, a current estimated position of the augmented reality device; and
storing in association with the environment map, a pinned position for the virtual object based on the current estimated position of the augmented reality device.
